(19) United States
(12) Patent Application Publication
(10) Pub. No.: US 2006/0105123 A1
(43) Pub. Date: May 18, 2006

(54) Water-resistant containers and a method to make such containers

(76) Inventor: Brett Camp, Spring, TX (US)

Correspondence Address: JAMES H. RILEY II, 14781 MEMORIAL DR., # 160, HOUSTON, TX, 77079, US

(21) Appl. No.: 10/988,671

(22) Filed: Nov. 15, 2004

(51) Int. Cl. B32B 27/10

(52) U.S. Cl. 428/34.2

(57) ABSTRACT

A method for making a water-resistant package with graphics on the exterior of the packaging wherein the desired graphics are printed on the packaging material or on a thin water-resistant vinyl sheet adhered to the packaging material to form a printed packaging material. A water-resistant transparent sheet is applied over the printed packaging material to form a combined packaging material. This transparent sheet adds an additional moisture barrier and protects the printed graphics from the elements. Finally, the combined packaging material is cut to form the water-resistant package having the desired graphics.

### CROSS-REFERENCE TO RELATED APPLICATIONS

Not Applicable.

### STATEMENT REGARDING FEDERALLY SPONSORED RESEARCH

Not Applicable.

### REFERENCE TO MICROFICHE APPENDIX

Not Applicable.

### FIELD OF THE INVENTION

This invention relates to boxes or similar containers. More specifically, this invention relates to water-resistant containers having graphics on exterior surfaces and a method to make such containers.

### BACKGROUND OF THE INVENTION

Package manufacturers commonly print graphics on their products. Such graphics serve to identify the customer's goods that will go inside the containers. Some customers of the package manufacturer need water-resistant containers and graphics on those containers because their product may be stored outdoors by their customers. For example, in the oilfield, a supplier of drill bits will ship the bit in a package that identifies the manufacturer of the bit and the type of bit. The service company in the field might put that package on the ground at the well site until it is needed. If the package and graphics are not water-resistant, the package will fall apart or the graphics will become unrecognizable in a very short time.

U.S. Pat. No. 6,076,332, which is incorporated herein by reference, discloses one method of making a weather resistant box using a vinyl substrate to cover the solid fiberboard. The printing on the vinyl is protected from the weather by applying a liquid clear coat. While the vinyl substrate does provide water resistance for the package material, it has been discovered that this liquid clear coat is easily scratched off during shipping which exposes the ink to the elements. Thus, there still exists a need in the industry for a water-resistant package and graphics.

### BRIEF SUMMARY OF THE INVENTION

It has been discovered that a thin, transparent sheet can be used to protect the printed graphics on packaging material and help make the graphics and packaging material water-resistant. The graphics can be printed directly on the packaging material or can be printed on a sheet, such as vinyl, which is subsequently adhered to the packaging material.

The invention uses a printing process, such as lithography or silk screening, to imprint an ink onto the packaging material or vinyl sheet. The preferred ink is a solventless, ultraviolet ink, and the preferred transparent substrate is a polyester film, such as Mylar®. The especially preferred embodiment includes printing a solventless, ultraviolet ink on a vinyl sheet, adhering that vinyl sheet to packaging material, and adhering a Mylar sheet over the printed side of the vinyl. This embodiment provides two water-resistant layers and allows the manufacturer to control the background color on the graphics. The printed vinyl sheet is attached to flat packaging material, such as solid fiberboard, using an adhesive, preferably placed on the back of the vinyl sheet to form a printed packaging material. Finally, the transparent polyester sheet is adhered over the printed side of the vinyl to form a combined packaging material and is cut to form the desired package.

### BRIEF DESCRIPTION OF THE VIEWS OF THE DRAWINGS

Not Applicable.

### DETAILED DESCRIPTION OF THE INVENTION

This invention relates to water-resistant containers having graphics on exterior surfaces and to a process for making such packaging. It has been discovered that a thin, transparent sheet can be used to protect the printed graphics on packaging material and help make the graphics and packaging material water-resistant. The graphics can be printed directly on the packaging material or can be printed on a sheet, such as vinyl, which is adhered to the packaging material.

The invention uses a printing process, such as lithography or silk screening, to imprint an ink onto the packaging material or vinyl sheet. The preferred ink is a solventless, ultraviolet ink, and the preferred transparent sheet is a polyester film, such as Mylar®. The especially preferred embodiment includes printing a solventless, ultraviolet ink on a vinyl sheet, adhering that vinyl sheet to packaging material, and adhering Mylar over the printed side of the vinyl. This embodiment provides two water-resistant layers and allows the manufacturer to control the background color on the graphics. The printed vinyl sheet is attached to flat packaging material, such as solid fiber board, using an adhesive, preferably placed on the back of the vinyl sheet to form a printed packaging material. Finally, the transparent sheet is adhered over the printed side of the vinyl to form a combined packaging material and is cut to form the desired package.

The discovered process permits the manufacturer to imprint graphics on the exterior of packaging material and protect those graphics from the elements. The preferred process involves printing graphics onto a vinyl sheet. An example of this process involves using a high quality polymeric vinyl sheet, preferable CV400-P Series manufactured by Catalina Plastics and Coating. The preferred polymeric vinyl sheet has a thickness of about 4 mils and is back coated with a thin coating of an aggressive acrylic permanent pressure sensitive adhesive, creating a vinyl sheet with a final thickness between about 4.5 and about 4.7 mils. This adhesive backing functions to attach the vinyl sheeting to a solid fiber board after the vinyl sheeting has been printed with the desired graphics. This vinyl sheet is water-resistant, and it helps make the solid fiberboard more water-resistant. This process will also work on corrugated board, but solid fiberboard is preferred.

The preferred process uses a sheet-fed press for printing. A printing press using high quality graphics plates imprints the desired image onto the vinyl sheet. It is especially preferred that the printing process use ultraviolet (UV) inks, which are solventless inks that cure with the application of UV light. Such inks not only provide sharp images on the vinyl sheet, but they are also water-resistant. An additional advantage of such inks is that they provide a dry product that is ready for further processing. Best results have been obtained when using styrene-based inks. Such inks contain high solids, are quick reacting, and are made especially for application on plastic substrates.

The water-resistant vinyl sheet, imprinted with the graphics, is attached to the desired packaging material to form a printed packaging material. Preferably, the vinyl sheet is applied to a flat, solid, fiberboard using an adhesive placed on the back of the vinyl sheet. Typically, the solid fiberboard is made from cellulose fibers, and it is more durable than corrugated board. For best results in the adhesion step, the application process should be conducted under temperature conditions above 35° F.

After applying the vinyl sheet to the flat, solid fiberboard, a thin, transparent sheet is applied over the printed side of the vinyl to form a combined packaging material. This sheet can be made from a variety of materials, such as polyvinyl, polypropylene, polyester, polyethylene, polycarbonate, poly(vinyl acetate), poly(vinyl acrylic), polystyrene, poly(ethylene terephthalate), or poly(ethylene terephthalate glycol), but polyester is preferred. The especially preferred polyester is two mills thick with a water-proof pressure sensitive adhesive on one side. This polyester sheet is commercially available from DuPont under the trademark Mylar®. This sheet adds another moisture barrier to the packaging, but more importantly adds a protective layer over the graphics.

In the last step of the package manufacturing process, the combined package material is die cut to the desired size and shape and is stitched using metal stitches to form the final packaging product. This final package manufacturing step is well known in the industry and need not be described further.

The foregoing disclosure and description of the invention are illustrative and explanatory thereof, and various changes in the details of the illustrated method of operation may be made without departing from the spirit of the invention.

What I claim is:

1. A method of making a water resistant package having graphics on its exterior, the method comprising:
(a) imprinting the desired graphics on the exterior side of a packaging material with an ink to form a printed packaging material;
(b) adhering a transparent sheet over the printed packaging material to form a combined packaging material; and,
(c) cutting and stitching the combined packaging material to form the package.

2. The method of claim 1 wherein the transparent sheet is polyester.

3. The method of claim 2 further comprising attaching the polyester sheet to the printed packaging materials using adhesives placed on the backside of the polyester sheet.

4. The method of claim 1 wherein the fibrous sheet is made from cellulose.

5. The method of claim 4 wherein the fibrous sheet is a solid fiberboard.

6. The method of claim 4 wherein the fibrous sheet is a corrugated board.

7. A method for making a water-resistant package having graphics on its exterior, the method comprising:
(a) imprinting the desired graphics on one side of a vinyl sheet with an ink;
(b) adhering the other side of the vinyl sheet to a fibrous sheet to form a printed packaging material;
(c) adhering a transparent sheet over the printed packaging material to form a combined packaging material substrate; and,
(d) forming the package from the combined packaging material substrate.

8. The method of claim 7 wherein the transparent sheet is polyester.

9. The method of claim 8 further comprising attaching the polyester sheet to the printed packaging materials using adhesives placed on the backside of the polyester sheet.

10. The method of claim 7 further comprising attaching the vinyl sheet to the packaging materials using adhesives placed on the backside of the vinyl sheet.

11. The method of claim 7 wherein the fibrous sheet is made from cellulose.

12. The method of claim 11 wherein the fibrous sheet is a solid fiberboard.

13. The method of claim 11 wherein the fibrous sheet is a corrugated board.

14. A water-resistant package comprising a packaging material having graphics on its exterior and a transparent sheet adhered to and covering the packaging material.

15. The package of claim 14 wherein the packaging material is solid fiberboard.

16. The package of claim 14 wherein the packaging material is corrugated board.

17. A water-resistant package having graphics on its exterior, the package comprising:
(a) a packaging material;
(b) a thin vinyl sheet adhered to and covering the exterior of the packaging material;
(c) a graphic printed on the vinyl sheet; and,
(d) a transparent sheet adhered to and covering the graphic-printed vinyl sheet.

18. The package of claim 17 wherein the packaging material is solid fiberboard.

19. The package of claim 17 wherein the packaging material is corrugated board.

20. The package of claim 17 wherein the adhesive is a pressure sensitive adhesive applied to one side of the vinyl and transparent sheets.
